(19) United States
(12) Patent Application Publication
(10) Pub. No.: US 2015/0203246 A1
(43) Pub. Date: Jul. 23, 2015

(54) MODULAR LOAD BEARING STRUCTURE

(71) Applicant: Tad V. Machrowicz, Ortonville, MI (US)

(72) Inventor: Tad V. Machrowicz, Ortonville, MI (US)

(21) Appl. No.: 14/599,856

(22) Filed: Jan. 19, 2015

Related U.S. Application Data
(60) Provisional application No. 61/930,639, filed on Jan. 23, 2014.

(51) Int. Cl. B65D 19/38; F16M 13/00

(52) U.S. Cl. CPC B65D 19/38; F16M 13/00; B65D 2519/00024; B65D 2519/00273; B65D 2519/00293; B65D 2519/00323; B65D 2519/00547; B65D 2519/0087

(57) ABSTRACT

A modular load bearing structure is configured from a plurality of structural members which are engageable with one another so as to define a load bearing structure having planar first and second faces disposed in a spaced apart plane parallel relationship. The structural members include engagement features which allow the members to be assembled into a load bearing structure. The members may be at least partially hollow structures and may be fabricated by blow molding. In some instances, the members may be multi-part members assembled from a plurality of separate elements.

### CROSS-REFERENCE TO RELATED APPLICATIONS

This patent application claims priority of U.S. Provisional Patent Application Ser. No. 61/930,639, filed Jan. 23, 2104, and entitled “Modular Load Bearing Structure,” which application is incorporated herein by reference.

### FIELD OF THE INVENTION

This invention relates generally to load bearing structures such as pallets and the like. More particularly, the invention relates to a modular assembly which may be configured into a variety of different load bearing structures.

### BACKGROUND OF THE INVENTION

For ease of handling, cargo is typically shipped and stored on pallets or other load bearing structures. Initially, pallets and the like were configured as simple wooden structures defining a generally planar face for supporting the cargo and further including notches or other such features which were configured to accommodate lift forks and other cargo handling apparatus. In order to increase the durability of such pallets and thereby facilitate their reuse, the industry has turned, at least in part, to the use of pallets fabricated from metals, polymers, and composites. In some instances, pallets have been configured as modular units comprised of a plurality of components which can be assembled into various configurations as needed and subsequently broken down for storage or reuse.

Any such pallet systems should be simple to use, low in cost, and adaptable to a variety of applications. As will be explained in detail herein below, the present invention is directed to a modular system for assembling pallets and other load bearing structures. The system of the present invention includes a plurality of members which can be readily engaged with one another and which are configured so that each of the members provides a portion of both a top and a bottom face of the pallet structure. The system of the present invention is light in weight yet very durable, and may be fabricated from a variety of materials including metals, polymers, and composites. These and other advantages of the invention will be apparent from the drawings, discussion, and description which follow.

### SUMMARY OF THE INVENTION

Disclosed is a modular load bearing system comprised of a plurality of structural members which are engageable with one another so as to define a load bearing structure having generally planar first and second faces which are disposed in a spaced apart, plane parallel relationship. The structural members each include an engagement feature which allows it to engage with another one of said structural members. The structural members each also include a first and second generally planar surface which surfaces are disposed in a spaced apart plane parallel relationship.

Each of the members are configured so that when a first one of the members is engaged with a second one of the members, the first surface of said first member and the first surface of said second member are in a generally coplanar relationship and define at least a portion of the first face of the load bearing structure, and the second surface of the first member and the second surface of the second member are in a generally coplanar relationship with one another and define at least a portion of the second face of the load bearing structure.

The members may be at least partially hollow and may be fabricated from metals and/or polymeric materials as well as composites. In some instances, the members may be configured as multi-part members having a first and second end portion which includes engagement features, and a central portion which joins the first and second portions. The central portion may be removably engageable with the end portions so as to allow for the adjustment of the length of the multi-part member. In some instances, the central portion may comprise several separate segments joined together by a connector element.

Also disclosed are modular installations of the members as well as methods for utilizing the load bearing system.

### BRIEF DESCRIPTION OF THE DRAWINGS

FIG. 1-A shows one embodiment of a structural member of the present invention including a first connection feature, and FIG. 1-B shows an alternative connection feature which may be utilized in the present invention;

FIG. 2 shows the use of the structural members of the present invention to assemble a pallet structure;

FIG. 3 shows an embodiment of a multi-part structural member of the present invention; and

FIG. 4 shows a coupler block which may be utilized in connection with the multi-part member of FIG. 3.

### DETAILED DESCRIPTION OF THE INVENTION

The present invention is directed to a modular load bearing structure which is comprised of a plurality of individual structural members which are engageable with one another so as to define a pallet or other load bearing structure. The load bearing structure has a first and a second face which are generally planar and which are disposed in a spaced apart, generally plane parallel relationship. Each structural member includes an engagement feature which allows it to engage and be retained by another one of the structural members.

Each of the members is configured so that when a first one of the members is engaged with a second one of the members, the first surface of the first member and the first surface of the second member are in a generally coplanar relationship with one another and define at least a portion of the first face of the load bearing structure. The members are further configured so that, when engaged, the second surface of the first member and the second surface of the second member are also in a generally coplanar relationship and define at least a portion of the second face of the load bearing structure. In the context of this disclosure, the language “generally coplanar” acknowledges the fact that the two planes may not be precisely aligned owing to irregularities in materials and tolerances, and/or the need to include minor misalignments of the elements to accommodate decking, brackets, specialized cargo, or the like.

The system of the present invention may be implemented in a variety of embodiments. One specific embodiment is shown herein, and it is to be understood that other implementations of the present invention are contemplated and readily apparent to those of skill in the art.

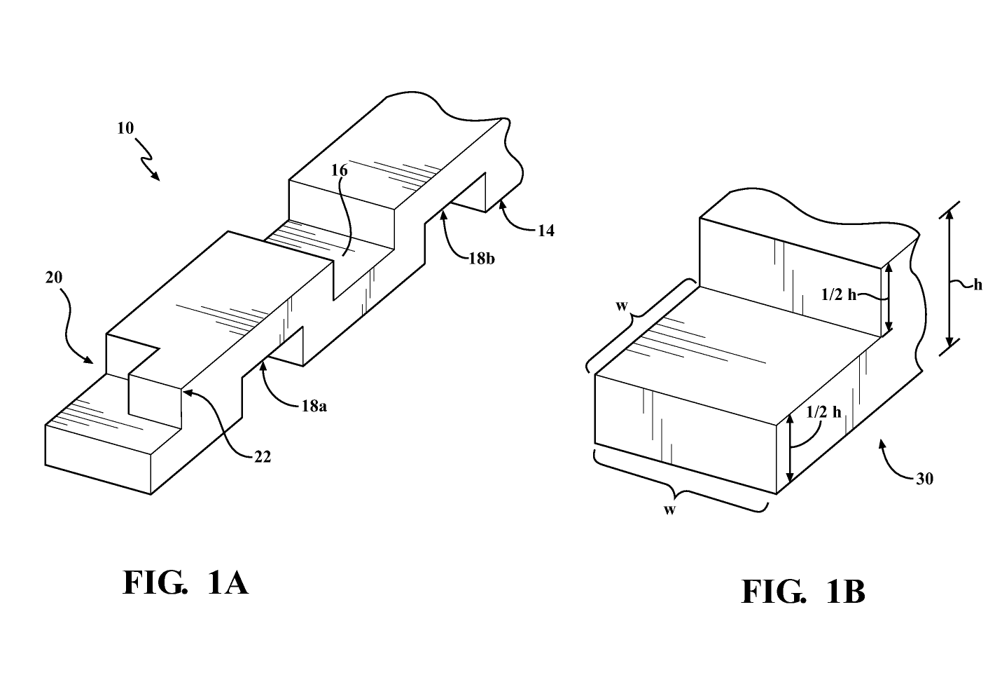

Referring now to FIG. 1-A, there is shown, at reference numeral 10, one embodiment of a structural member which may be used in the practice of the present invention. This embodiment, 10, comprises a generally elongated beam having a first, generally planar surface 12 (top surface) and a second, generally planar surface 14 (bottom surface). These surfaces 12, 14 are spaced apart from one another in a generally plane parallel relationship; and as will be explained hereinbelow, these surfaces will define portions of the top and bottom face of the pallet when assembled. The member 10 includes a number of engagement features which allow it to be joined to other members so as to form the load bearing structure. As shown in FIG. 1-A, the member 10 includes a top surface groove 16 proximate its midportion and bottom surface grooves 18a, 18b. These grooves 16, 18 allow the members to engage one another. In addition, the bottom grooves 18a, 18b can be positioned so as to accommodate a lift fork in the assembled pallet structure. The member 10 further includes an additional engagement feature 20 at its end. In this embodiment, the engagement feature 20 is a dual notch having a locking tang portion 22. As will be appreciated by those of skill in the art, this engagement feature 20 will mate with a like engagement feature so as to provide a joint which is stabilized with regard to several degrees of rotation. It will further be appreciated by those of skill in the art that otherwise configured engagement features such as sockets, post and/or pin assemblies, dovetails, chamfers, and the like may also be incorporated into engagement features. In some embodiments, the engagement features may include screws, tabs, adhesive, or other such means for facilitating the engagement of the members.

It is a notable feature of the present invention that the engagement features can be configured so that when two of the members are engaged, their top surfaces will be in a generally coplanar relationship, as will be their bottom surfaces. In this regard, in the member 10 of FIG. 1-A, the height and depth of the notches is selected so as to be one half of the spacing between the first surface 12 and second surface 14 of the member 10. As will be apparent to those of skill in the art, other geometric relationships may be employed to achieve this type of coplanar connection.

FIG. 1-B further illustrates another embodiment of connection feature at reference numeral 30. In this instance, the connection feature comprises a simple stepped notch disposed at the end of a member. This notch, as will be seen from the drawing, is configured so that its height is one half of the total height of the member. Likewise, the width of the notch is equal to the width of the beam. In this manner, two beams may be engaged in such a manner so that their surfaces will be in a coplanar relationship as discussed above. Yet other embodiments of engagement features will be apparent to those of skill in the art.

The structural members of the present invention may be fabricated from a variety of materials. In some particular instances, they will be fabricated as hollow tubular members. In specific instances, the members are fabricated as hollow tubular members comprised of thin walled, relatively high strength metals, which can include ferrous metals as well as nonferrous metals. In some such instances, the hollow tubular members may be fabricated by pressure forming methods such as blow molding in which a pressurized gas is introduced into a hollow tubular member which is shaped in a mold, die, or other such forming structures. As is known in the art, the workpiece may be optionally heated, and/or compressed, and/or stretched during the pressurizing and forming steps. In other instances, the members may be fabricated by welding, casting, bending, forging, or any other such known metalworking techniques.

In yet other instances, the members may be fabricated from polymeric materials. In some particular instances they may be fabricated by blow molding processes, and in yet other instances they may be fabricated by casting, injection molding, rotational molding, or the like. The members may be solid or hollow, and in the instance of solid members they may include lightweight fillers to decrease their density. In yet other instances, the members may be fabricated from composites such as reinforced polymer, metal/organic composites, and the like.

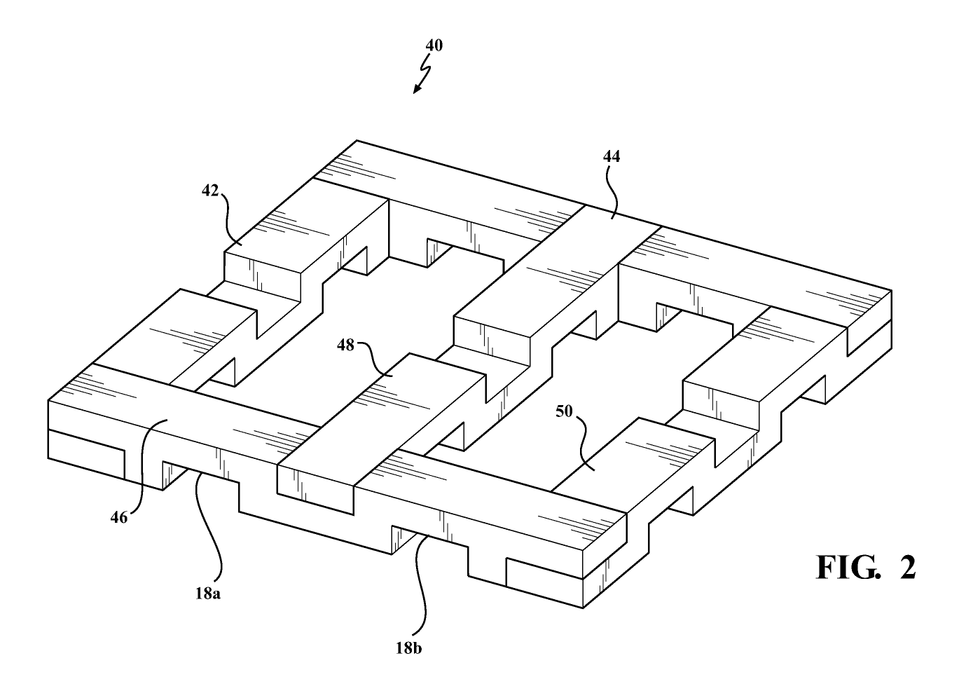

Referring now to FIG. 2, there is shown an embodiment in which the structural members are assembled so as to form a pallet structure. The structure 40 of FIG. 2 shows structural members 42, 44, 46, 48, and 50 being assembled in an interlocked structure so as to define a pallet surface. As will be noted, the coupling feature allows the structural members to engage and be retained by one another. In addition, the notched portions of the structural members provide pockets, 18a and 18b, through which a lift fork can be inserted. Although not shown, a central reinforcing member may be placed so as to extend from structural member 42 to structural member 48 and thence to structural member 50 thereby further reinforcing the structure. Likewise, lower members may be similarly placed. Other reinforcing and/or structural elements such as rods, brackets, cables, bars, and the like may also be incorporated into the pallet structure.

As discussed above, the system of the present invention defines a load bearing structure having spaced apart upper and lower faces which are at least in part defined by surfaces of the structural members. These faces may be utilized to directly support cargo thereupon. Alternatively, the faces may be configured so as to receive a sheet or other body of decking material, and in that regard may include recesses, attachment features or the like, configured to retain the decking material. The decking body may itself be notched or otherwise configured to engage another decking body and/or the structural members. In addition, the decking body may be configured to include cargo retaining features such as grooves, tie downs, and the like.

As will be apparent from reference to the figures and specification, the structure shown in FIG. 2 may be extended to provide variously configured support surfaces. Thus, while the invention has been described primarily with reference to support structures comprising pallets, it is to be understood that the principles hereof can be utilized in conjunction with other support structures such as floor structures, building components, decks, and any other load bearing, generally planar surface.

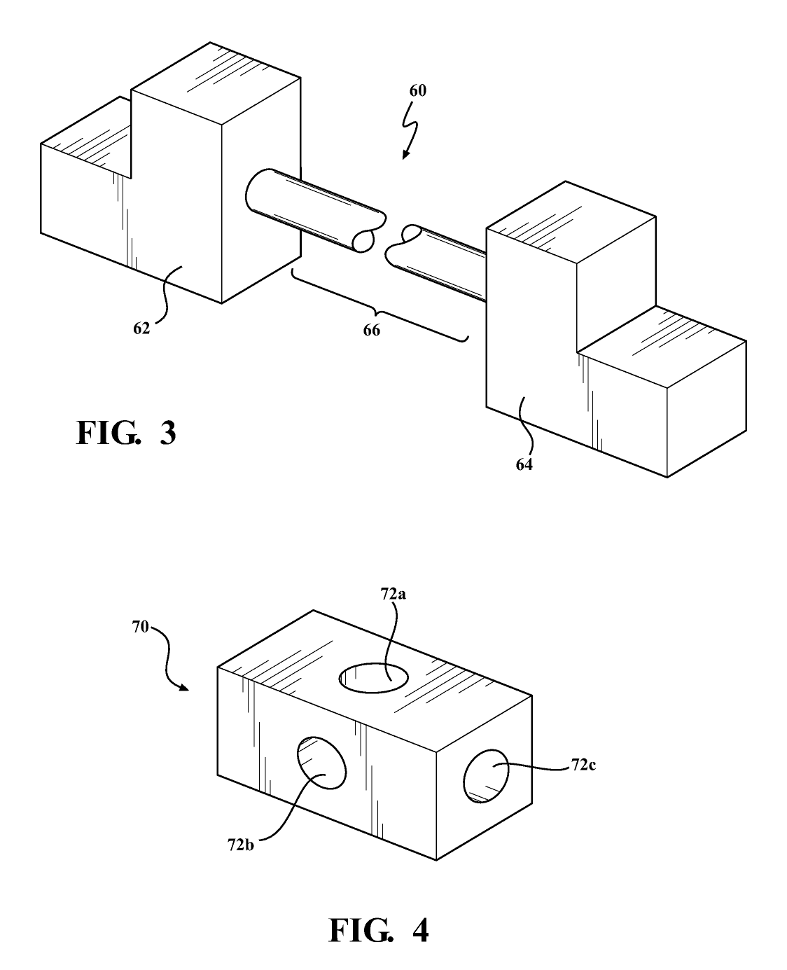

The present invention may be implemented in yet other configurations. For example, in some instances, the structural members may be configured to be multi-part members; and one embodiment of multi-part member is shown in FIG. 3 at reference numeral 60. The multi-part member 60 includes a first end portion 62 and a second end portion 64 each of which includes engagement features which allow it to engage another similar member as described previously. In this regard, the engagement features may be simple, step members as shown at reference numeral 30 in FIG. 1, or they may be more complex shapes such as the locking tang including engagement features 20 of FIG. 1.

The end portions 62, 64 are joined together by a central portion 66, which in this embodiment is shown as a rod or tube-like portion, and as indicated by the break line, this portion can be of various lengths. In other instances, the central portion may comprise an I-beam like structure, a channel, a square cross-section tube, or any other structure as will be readily apparent to those of skill in the art. As will be seen from FIG. 3, the central portion has a width which is less than the height of the end portions, and thus in use, provides clearance space for insertion of a lift fork or the like.

The central portion may be permanently affixed to the end portions 62-64; however, in other instances, the multi-part member may be configured so that the central portion is removable. In this regard, a socket or the like will be provided in the end portion 62, 64 and, as is known in the art, can include locking features such as flanges or the like. Use of a removable central portion allows for the adjustment of the length of the overall member to suit particular applications.

In some instances, the central portion of the multi-part member may comprise two or more separate segments joined together by a coupling member, such as the coupling member 70 shown in FIG. 4. In the FIG. 4 embodiment, the coupling member 70 has a height and width generally corresponding to the height and width of the end portions of the multi-part member. In this manner, the coupler 70 can function to provide additional support in those instances where the span between the end portions is relatively long, while the remaining portions of the central member will provide clearance space for lift forks or the like.

As will be seen from FIG. 4, the coupler 70 includes sockets 72a, 72b, and 72c on its faces. These sockets allow the multi-part member to be assembled into various configurations. For example, by utilizing end socket 72 and a corresponding socket (not shown), the coupler 70 may be interposed between the end portions 62, 64 of the FIG. 3 embodiment. By utilizing the additional sockets, for example sockets 72a and 72b, further central portions may be coupled to additional end portions so as to assemble structural members having two- or three-axis geometry. Such multi-axis members can provide additional strength in instances where very heavy loadings are encountered. In view of the teaching presented herein, yet other embodiments of the invention will be readily apparent to those of skill in the art.

The foregoing drawings, discussion, and description are illustrative of specific embodiments of the invention but are not meant to be limitations upon the practice thereof. It is the following claims, including all equivalents, which define the scope of the invention.

1. A modular load bearing structure comprising:
a plurality of structural members which are engageable with one another so as to define a load bearing structure having generally planar first and second faces which are disposed in a spaced apart, generally plane parallel relationship; said structural members each including an engagement feature which allows it to engage another one of said structural members, said structural members each including a first and a second generally planar surface which surfaces are disposed in a spaced apart, plane parallel relationship; each of said members being configured so that when a first one of said members is engaged with a second one of said members, the first surface of said first member and the first surface of said second member are in a generally coplanar relationship with one another and define at least a portion of the first face of said load bearing structure, and the second surface of said first member and the second surface of said second member are in a generally coplanar relationship with one another and define at least a portion of the second face of said load bearing structure.

2. The structure of claim 1, wherein said members are hollow members.

3. The system of claim 1, wherein said structural members are comprised of a metal.

4. The system of claim 3, wherein the metal is selected from the group consisting of: aluminum, aluminum alloys, steel, magnesium, magnesium alloys, titanium, titanium alloys, and combinations thereof.

5. The system of claim 1, wherein said engagement features comprise notches.

6. The system of claim 1, wherein said engagement features include a coupling member.

7. The system of claim 1, wherein said load bearing structure is a pallet.

8. The system of claim 1, wherein said load bearing structure is configured so as to be engageable by a lift fork.

9. The system of claim 1, wherein said load bearing structure is comprised entirely of said structural members.

10. The system of claim 1, wherein when said system is assembled so as to comprise said load bearing structure, at least one of the faces of said load bearing structure being configured to receive decking material.

11. The system of claim 1, wherein all of said structural members are identical.

12. The system of claim 1, wherein said structural members are of at least two different configurations.

13. The system of claim 1, wherein said structural members are hollow members formed in a blow molding process.

14. The system of claim 1, wherein at least one of the structural members is a multi-part member which includes a first and a second end portion and a central portion connecting said end portions.

15. The system of claim 14, wherein said central portion includes at least two separate segments.

16. The system of claim 15, wherein said at least two segments are joined by a connector.

17. A method for assembling a load bearing structure comprising the use of the system of claim 1.
